(19) United States
(12) Patent Application Publication
(10) Pub. No.: US 2026/0071662 A1
(43) Pub. Date: Mar. 12, 2026

(54) HEEL CONTROL SEAL GLAND FOR DISC BRAKE PISTON SEALS

(71) Applicant: Fox Factory, Inc., Duluth, GA (US)

(72) Inventor: Bill Becker, Aptos, CA (US)

(21) Appl. No.: 18/828,731

(22) Filed: Sep. 9, 2024

(51) Int. Cl. F16D 65/74; F16D 65/18; F16D 121/04; F16D 125/08

(52) U.S. Cl. CPC F16D 65/74; F16D 65/18; F16D 2121/04; F16D 2125/08

(57) ABSTRACT

A disc brake with a heel control seal gland is provided. The disc brake includes a heel control seal gland formed in a piston bore, wherein the heel control seal gland includes a narrow gland portion and a wide gland portion. The disc brake further includes a piston seal coupled within the heel control seal gland. A heel of the piston seal is coupled within the narrow gland portion. The narrow gland portion has a width sized to the heel of the piston seal width with additional clearance. Also, the width of the narrow gland portion is less than the width of the wide gland portion. The heel control seal gland controls axial movement of the piston seal and the piston in a direction away from the rotor caused by warpage of the brake rotor applying a force on the piston away from the rotor.

### BACKGROUND OF THE INVENTION

### Technical Field

This invention relates generally to a seal gland for disc brake piston seals and more particularly to a heel control seal gland for disc brake piston seals.

### State of the Art

It is common for disc brake calipers to have a square female gland and square O-ring seal for the disc brake pistons. The gland width is typically sized to give a percent fill range of about 60-85% where the range variation is from the tolerances of the seal and machined seal gland. After the disc brakes have been applied, the fluid pressure drops to zero and the piston seals retract by the amount of the axial chamfer. As the vehicle moves after the disc brakes are released the lateral runout (i.e. warpage) of the brake rotors can push back the pistons further into the cylinder bores. When this occurs, it can increase the brake pedal or lever movement to bring the pistons and brake pads close to the brake rotor. This variation is not desirable because it gives the driver/rider of the vehicle an unsure feeling about brake repeatability.

Accordingly, there is a need for a seal gland for a disc brake piston seal that controls the heel movement of the piston seal to limit movement of the piston away from rotor and into the piston bores.

### SUMMARY OF THE INVENTION

An embodiment includes a disc brake comprising: a heel control seal gland formed in a piston bore, wherein the heel control seal gland comprises a narrow gland portion and a wide gland portion; and a piston seal coupled within the heel control seal gland, wherein: a heel of the piston seal is coupled within the narrow gland portion; the narrow gland portion has a width sized to the heel of the piston seal width with additional clearance; and the width of the narrow gland portion is less than the width of the wide gland portion.

Another embodiment includes a method of using a disc brake with a heel control seal gland, the method comprising: coupling a disc brake with a heel control seal gland to a brake rotor of a vehicle, wherein the disc brake comprises: a heel control seal gland formed in a piston bore, wherein the heel control seal gland comprises a narrow gland portion and a wide gland portion; and a piston seal coupled within the heel control seal gland, wherein: a heel of the piston seal is coupled within the narrow gland portion and contacting a piston of the within the piston bore; the narrow gland portion has a width sized to the heel of the piston seal width with additional clearance; and the width of the narrow gland portion is less than the width of the wide gland portion; in response to lateral runout of the brake rotor, applying a force to the piston toward the piston bore and moving the piston and piston seal in direction away from the rotor; and limiting movement of the piston and the piston seal away from the rotor in response to the heel of the piston seal contacting a surface of the narrow gland portion located furthest from the rotor.

Another embodiment includes a method of controlling piston seal and piston drift of a disc brake, the method comprising: applying lateral runout by a brake rotor to a brake pad of the disc brake because of warpage of the brake rotor; controlling axial movement of a piston seal and a piston in a direction away from the rotor in response to a heel control seal gland limiting movement of a heel of the piston seal coupled within the heel control seal gland; and maintaining brake pedal or lever movement needed for braking in response to controlling axial movement of the piston seal and the piston.

The foregoing and other features and advantages of the present invention will be apparent from the following more detailed description of the particular embodiments of the invention, as illustrated in the accompanying drawings.

### BRIEF DESCRIPTION OF THE DRAWINGS

A more complete understanding of the present invention may be derived by referring to the detailed description and claims when considered in connection with the Figures, wherein like reference numbers refer to similar items throughout the Figures, and:

FIG. 1 is a perspective section view of a prior art disc brake coupled to a rotor;

FIG. 2 is a zoomed perspective section view of the prior art disc brake shown in FIG. 1; and

FIG. 3 is a section view of a disc brake assembly with a heel control seal gland according to an embodiment.

### DETAILED DESCRIPTION OF EMBODIMENTS OF THE INVENTION

As discussed above, embodiments of the present invention relate to a seal gland for a disc brake piston seal that controls the heel movement of the piston seal to limit movement of the piston away from rotor and into the piston bore. Embodiments of the heel control seal gland operate to hold the O-ring seal biased towards the brake pad where the narrow “heel control” portion of the gland prevents the seal from drifting away from the rotor when the brake pressure is released. In one embodiment, the O-ring seal may be square in cross section. In other embodiments, the O-ring seal may have different cross sectional shapes, such as rectangular.

One advantage to this invention is that it can provide a more consistent solid brake pedal or lever feeling with less “brake bite point” variation. The heel control seal gland has a sized wide portion which accommodates the percent fill of the gland due to the seal and machined gland tolerances.

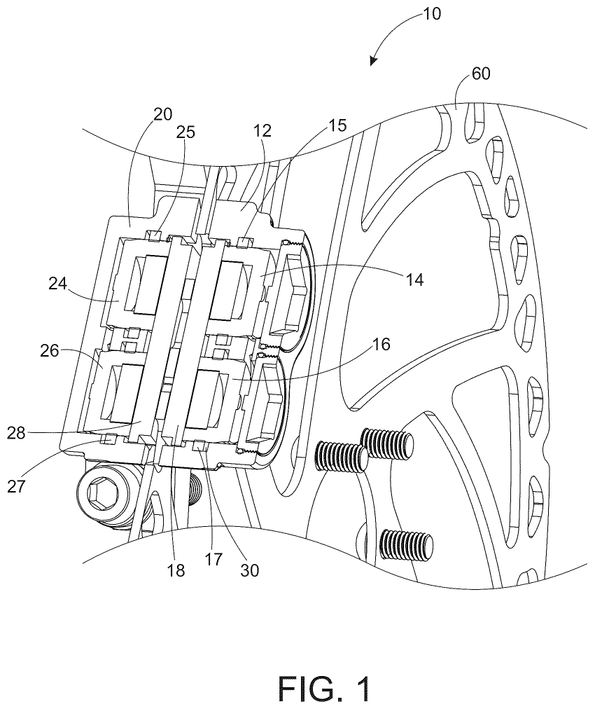

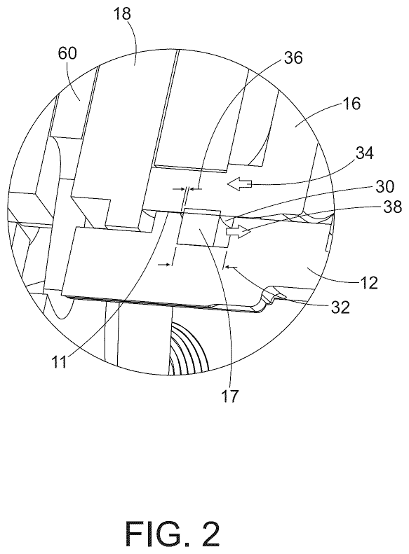

Referring to FIGS. 1-2, a disc brake 10 is depicted coupled to a rotor 60. The disc brake 10 includes an inner portion 12 having a trailing brake piston 14 with a piston seal 15, a leading piston 16 with a piston seal 17 and an inner brake pad 18. The disc brake 10 also includes an outer portion 20 having a trailing brake piston 24 with a piston seal 25, a leading piston 26 with a piston seal 27 and an outer brake pad 28.

With specific reference to FIG. 2, the leading piston 16 with piston seal 17 of the inner portion 12 of the disc brake 10 may include a piston bore 11 comprising a square female gland 30 formed therein and sized and shaped to receive and retain a square piston seal 17 for the disc brake leading piston 16. It is understood that each of the pistons of the disc brake 10 includes a piston bore, a seal gland and a piston seal that are similar in size shape and structure as those being discussed with regard to the leading piston 16 and piston seal 17. The gland width 32 of the seal gland 30 is typically sized to give a percent fill range of about 60-85% where the range variation is from the tolerances of the seal 17 and machined seal gland 30. After the disc brakes have been applied moving the piston 16 under pressure and therefore the brake pad 18 toward the rotor 60 in direction 34, the fluid pressure drops to zero and the piston seals 17 retract by the amount of the axial chamfer 36. As the vehicle moves after the disc brakes are released the lateral runout (i.e. warpage) of the brake rotors 60 can push back the piston 16 further into the cylinder bore 11 moving the piston 16 and piston seal 17 in direction 38 away from the rotor 60. This movement can be as far as the gland width 32. When this occurs, it can increase the brake pedal or lever movement to bring the pistons, 14, 16, 24, 26 and brake pads 18 and 28 close to the brake rotor 60 because the system needs to account for the movement of the pistons and the seals away from the rotor 60 an amount that can be as much as the gland width 32 that is larger than a seal width of the piston seal 17. This variation is not desirable because it gives the driver/rider of the vehicle an unsure feeling about brake repeatability.

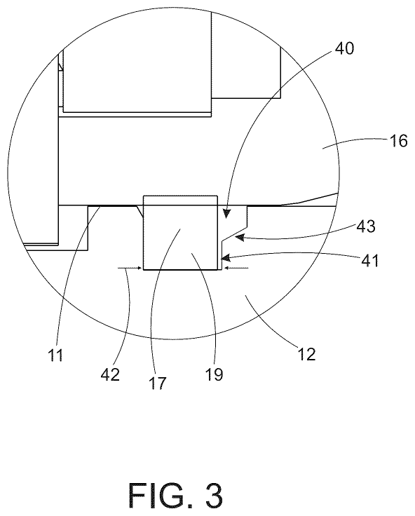

Referring to FIG. 3, an embodiment includes a heel control seal gland 40 formed in the piston bore 11. The heel control seal gland 40 comprises a narrow gland portion 41 and a wide gland portion 43. The narrow gland portion 41 is located where a heel of the seal 17 is located. The heel 19 of the seal 17 is the side of the seal 17 opposite of the side of the seal 17 that engages the surface piston 16. Accordingly, the narrow gland portion 41 has a width 42 sized to fit a piston seal 17 width with additional clearance to fit the seal at its max width. The width of the narrow gland portion 41 is less than the width of the adjacent wide gland portion 43. The wide gland portion 43 is sized to accommodate the percent fill of the gland 40, such as about 60-85%, based on the tolerances of the seal 17 and heel control seal gland 40. The heel control seal gland 40 operates by utilizing the narrow gland portion 41 to limit travel of the seal 17 caused by the lateral runout (i.e. warpage) of the brake rotor 60. This limits travel of the piston 16 and the seal 17 into the piston bore 11 due to force of the lateral runout of the rotor 60. Thereby, the increase brake pedal or lever movement is minimized or nearly eliminated and provides a repeatable and steady brake feeling by maintaining brake pedal or lever movement needed for braking.

An embodiment includes a method of using a disc brake 10 with a heel control seal gland 40. The method comprises coupling a disc brake 10 with a heel control seal gland 40 to a brake rotor 60 of a vehicle, wherein the disc brake 10 comprises the components indicated with respect to FIG. 3. The method may comprise, in response to lateral runout of the brake rotor 60, applying a force to the piston 16 toward the piston bore 11 and moving the piston 16 and piston seal 17 in direction away from the rotor 60, and limiting movement of the piston 16 and the piston seal 17 away from the rotor 60 in response to the heel 19 of the piston seal 17 contacting a surface of the narrow gland portion 41 located furthest from the rotor 60.

Another embodiment includes a method of controlling piston seal 17 and piston 16 drift of a disc brake 10. The method comprises applying lateral runout by a brake rotor 60 to a brake pad 26 of the disc brake 10 because of warpage of the brake rotor 60; controlling axial movement of a piston seal 17 and a piston 16 in a direction away from the rotor 60 in response to a heel control seal gland 40 limiting movement of a heel 19 of the piston seal 17 disposed within the heel control seal gland 40; and maintaining brake pedal or lever movement needed for braking in response to controlling axial movement of the piston seal 17 and the piston 16.

The embodiments and examples set forth herein were presented in order to best explain the present invention and its practical application and to thereby enable those of ordinary skill in the art to make and use the invention. However, those of ordinary skill in the art will recognize that the foregoing description and examples have been presented for the purposes of illustration and example only. The description as set forth is not intended to be exhaustive or to limit the invention to the precise form disclosed. Many modifications and variations are possible in light of the teachings above without departing from the spirit and scope of the forthcoming claims.

1. A disc brake comprising:
a heel control seal gland formed in a piston bore, wherein the heel control seal gland comprises a narrow gland portion and a wide gland portion; and
a piston seal disposed within the heel control seal gland, wherein:
a heel of the piston seal is disposed within the narrow gland portion;
the narrow gland portion has a width sized to the heel of the piston seal width with additional clearance; and
the width of the narrow gland portion is less than the width of the wide gland portion.

2. The disc brake of claim 1, wherein the wide gland portion is sized to accommodate a percent fill of the heel control seal gland.

3. A method of using a disc brake with a heel control seal gland, the method comprising:
coupling a disc brake with a heel control seal gland to a brake rotor of a vehicle, wherein the disc brake comprises:
a heel control seal gland formed in a piston bore, wherein the heel control seal gland comprises a narrow gland portion and a wide gland portion; and
a piston seal disposed within the heel control seal gland, wherein:
a heel of the piston seal is disposed within the narrow gland portion and contacting a piston within the piston bore;
the narrow gland portion has a width sized to the heel of the piston seal width with additional clearance; and
the width of the narrow gland portion is less than the width of the wide gland portion;
in response to lateral runout of the brake rotor, applying a force to the piston toward the piston bore and moving the piston and piston seal in direction away from the rotor; and
limiting movement of the piston and the piston seal away from the rotor in response to the heel of the piston seal contacting a surface of the narrow gland portion located furthest from the rotor.

4. The method of claim 3, wherein the wide gland portion is sized to accommodate a percent fill of the heel control seal gland.

5. The method of claim 4, further comprising accommodating a percent fill of the heel control seal gland in response to operation of the disc brake.

6. A method of controlling piston seal and piston drift of a disc brake, the method comprising:
applying lateral runout by a brake rotor to a brake pad of the disc brake because of warpage of the brake rotor;
controlling axial movement of a piston seal and a piston in a direction away from the rotor in response to a heel control seal gland limiting movement of a heel of the piston seal disposed within the heel control seal gland; and
maintaining brake pedal or lever movement needed for braking in response to controlling axial movement of the piston seal and the piston.

7. The method of claim 6, wherein the heel control seal gland is formed in a piston bore of the disc brake, wherein the heel control seal gland comprises a narrow gland portion and a wide gland portion.

8. The method of claim 7, wherein the heel of the piston seal is disposed within the narrow gland portion.

9. The method of claim 8, wherein the narrow gland portion has a width sized to the heel of the piston seal width with additional clearance, and the width of the narrow gland portion is less than the width of the wide gland portion.

10. The method of claim 9, wherein the wide gland portion is sized to accommodate a percent fill of the heel control seal gland.

11. The method of claim 10, further comprising accommodating a percent fill of the heel control seal gland in response to operation of the disc brake.
